(19) United States
(12) Patent Application Publication
(10) Pub. No.: US 2010/0271476 A1
(43) Pub. Date: Oct. 28, 2010

(54) METHOD FOR PROCESSING LIGHT IN A STRUCTURE AND A LIGHTING SYSTEM

(75) Inventors: Paulus H.A. Damink, Eindhoven (NL); Sel B. Colak, Eindhoven (NL); Lorenzo Feri, Eindhoven (NL); Hendricus T.G.M. Penning de Vries, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/668,036

(22) PCT Filed: Jul. 16, 2008
(86) PCT No.: PCT/IB08/52848

§ 371 Date: Jun. 8, 2010

(30) Foreign Application Priority Data
Jul. 18, 2007 (EP) 07112664.3

(51) Int. Cl. H04N 7/18

(52) U.S. Cl. 348/135; 348/E07.085

(57) ABSTRACT

This invention relates to a method for processing light in a structure, such as a room or a part thereof, a vehicle, etc., where several light sources are arranged in the structure. The light sources emit light carrying individual codes. A camera is arranged in a camera position of the structure and registers images of spots of the light. The spots can be, “for instance, illuminated areas of a floor or the direct light images of the light sources. The individual codes are derived from the registered images and one or more properties, such as for instance light source position or light intensity, related to the associated light source, is determined. The method is performed by means of a lighting system having several light sources, a camera, and a signal processing apparatus. Typical applications for the invention are light source commissioning and real time foot-print measurements.

### FIELD OF THE INVENTION

The present invention relates to a method for processing light in a structure having several light sources, which emit light carrying individual codes.

### BACKGROUND OF THE INVENTION

It is increasingly common to provide lighting systems in which the light sources are uniquely identifiable by means of some kind of individual code embedded in the light that is emitted from the light sources. The fact that the light sources are individually coded, and thus individually recognisable is useful for many different kinds of applications employing light processing, such as for instance controlling the lighting system by means of measuring intensity or other properties of the detected light, as disclosed in International Application WO 2006/111934, or for determining a position of an object that is reached by the light from the light sources, as disclosed in U.S. Pat. No. 6,865,347, or for commissioning the light sources. However, when installing the lighting system in a structure, typically it is not predetermined where each individual light source is to be mounted. Instead, after having mounted the light sources a procedure is performed for determining where in the structure each respective light source has been placed. When the light source position property has thus been determined it has been possible to determine other properties as well. So far position related determinations including associating emitted light with light source identity have been performed with a significant manual contribution, thereby suffering from the drawback of being time consuming. On the other hand, if some other light source property, such as light intensity has been determined, still manual participation has been significant.

### SUMMARY OF THE INVENTION

It is an object of the present invention to provide a method and a system that alleviates the above-mentioned drawbacks of the prior art by automating light source property determinations.

This object is achieved by a method for light processing according to the present invention as defined in claim 1, and by a lighting system according to the present invention as defined in claim 15.

The invention is based on an insight that by using a camera for registering images of the light emitted from the light sources after installation thereof, and recognizing the individual codes in the registered images, it is possible to obtain a fast and at least substantially automatic determination of light source properties.

Thus, in accordance with an aspect of the present invention, there is provided a method for processing light in a structure having several light sources, which emit light carrying individual codes. The method comprises:

arranging a camera in the structure in a camera position where the camera is able to register spots of said emitted light from the light sources:

registering, by means of said camera, images of said spots of light;

deriving said individual codes from the registered images; and

determining, for each individual code, at least one property related to the associated light source. Thus, by this method, since the camera is placed in a camera position and since it is possible to derive information about the individual codes from the light that is registered with the camera, it is advantageously possible to obtain desired information about the light sources automatically. Putting the camera in place, which is a relatively simple and quick operation, essentially constitutes the only manual action.

It should be noted that by the term “structure” means any structure that is arranged to carry light sources of the kind of interest, including but not limited to, a building, a room in a building, a vehicle, a roofed or confined area, etc.

In accordance with an embodiment of the method, as defined in claim 2, some kind of light source position is determined, such as a position related to the structure or to the camera, which is beneficial for several applications.

In accordance with an embodiment of the method, as defined in claim 3, the positions correspond to predetermined mounting positions. Since the light sources are arbitrarily mounted in the mounting positions it is not known in advance which light source has been mounted in which mounting position, but by means of the present method such a determination is performable. This light source position knowledge is typically employed in a commissioning application.

In accordance with an embodiment of the method, as defined in claim 4, the light source positions are instead related to the position of the camera, which is typically useful for other foot-print measurement applications as will be further described below.

In accordance with an embodiment of the method, as defined in claim 5, the at least one property comprises the determined light intensity of the light spots is. Thereby the method encompasses further operations such as controlling the emitted light, where the intensity is an important property.

In accordance with an embodiment of the method, as defined in claim 6, the individual codes are provided by means of modulating the light with individually coded modulation signals, preferably CDMA signals, as defined in claim 7. Such modulation provides for the possibility of using efficient methods for identifying the light sources. Further, as defined in claim 8, it is advantageous to synchronize the modulation signals. In an embodiment the registering is synchronized with said modulation signals. In an embodiment the light sources operate asynchronously.

In accordance with an embodiment of the method, as defined in claim 11, the spots of light comprise at least one of areas illuminated by the light sources, and output ends of the light sources. In other words, it is possible to locate the camera in different positions, where it registers images of indirect light coming from illuminated areas, such as areas of an illuminated floor, or directly from the light sources, such as when the camera is pointed obliquely upwards in the direction of a ceiling and thus towards the output ends of the light sources. Moreover, the light sources may be positioned on the walls of the structure. Depending on the camera position, it may be pointing obliquely upward, downward or sideways to the output ends and or light spots.

In accordance with an embodiment of the method, as defined in claim 12, it further comprises sending light source data to a master controller, which controls the light sources. It is an advantage to use a central master controller, which can be provided with a large computational capacity.

In an embodiment the method further comprises sending light source data, including intensity data related to said measured intensity of light, generated by means of said camera to a master controller, which controls the light sources. In yet another embodiment, the method further comprises mapping the light source positions to a layout of said mounting positions.

In accordance with another aspect of the invention, as defined in claim 15, there is provided a lighting system, which is arranged in a structure that has predetermined mounting positions, and which comprises several light sources, which are arbitrarily mounted at said mounting positions; a camera; and a signal processing apparatus. Each light source is provided with a light coder for individually coding the light emitted from the light source with an individual code. The camera is arranged to register images of spots of light emitted from the light sources. The signal processing apparatus is arranged to derive said individual codes from the registered images and determine at least one property related to the associated light source. For instance the property includes which one of the mounting positions each respective light source has been mounted.

The lighting system and embodiments thereof as defined in further claims, are capable of performing operations of the method already described above, and exhibit similar advantages. However, the following specific features should be noted.

In accordance with an embodiment of the lighting system, as defined in claim 21, the camera comprises an image detector comprising a matrix of detector elements each generating one pixel of the registered image. Thus, the image processing may be done pixel by pixel, which reduces the complexity thereof and enables the use of conventional relatively simple data processing.

These and other aspects, features, and advantages of the invention will be apparent from and elucidated with reference to the embodiments described hereinafter.

### BRIEF DESCRIPTION OF THE DRAWINGS

The invention will now be described in more detail and with reference to the appended drawings in which:

FIG. 1 illustrates an example of the arrangement of a lighting system;

FIG. 2 is a schematic block diagram of an embodiment of a lighting system according to the present invention;

FIG. 3 illustrates a schematic example of a layout of a structure;

FIG. 4 is a schematic flow chart of an embodiment of a method for processing light, according to this invention;

FIG. 5 is a schematic block diagram of another embodiment of a lighting system; and

FIG. 6 is a schematic flow chart of another embodiment of the method for processing light.

### DESCRIPTION OF PREFERRED EMBODIMENTS

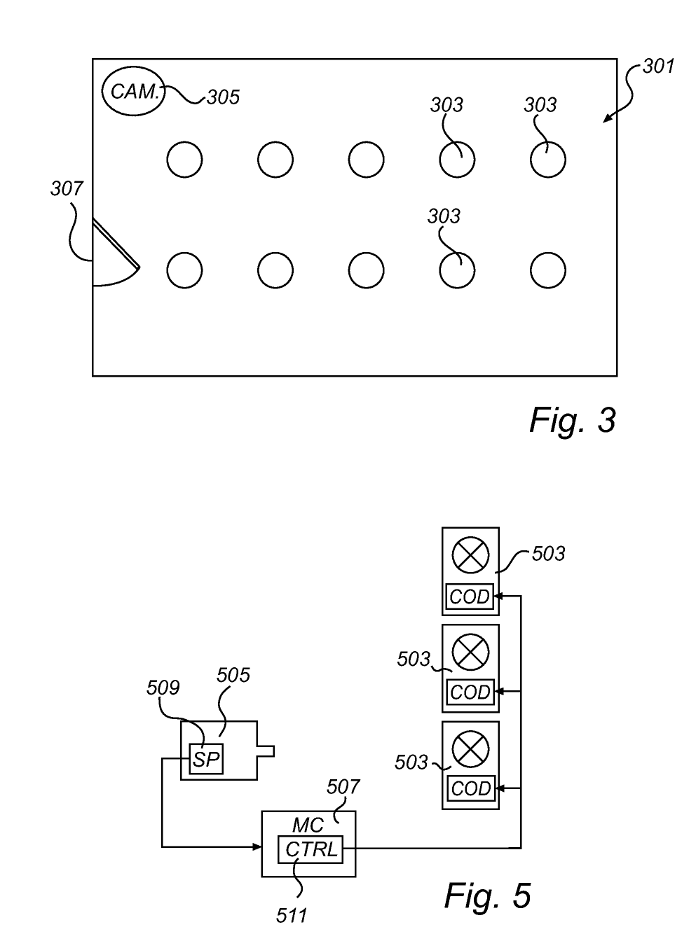

In an embodiment thereof the lighting system 101 comprises several light sources 103, which are mounted at the ceiling 105 of a structure, which here is a room, 107, and a camera 111, which is mounted at a corner of the room 107 to the left of the entrance 113, and close to the ceiling 105. The camera 111 is inclined downwards and has a wide angle lens, thereby registering the spots of light that the light sources 103 generate in the form of illuminated areas, here circles, 115 on the floor 109. The light sources 103 have been mounted at predetermined mounting positions 303 which, for example, are derivable from a layout 301 of the room, see FIG. 3. The light sources 103 emit light that has individual codes embedded therein. Thereby it is possible to identify each individual light source 103 and relate its identity to the mounting position 303 where it is mounted. The camera 111 is placed in a position of the room 107 that makes it possible for the camera 111 to see all spots of light 115, i.e. all spots of interest. This camera position has been determined in advance or is determined by means of a position determination device, see 215 in FIG. 2, provided in the camera 111. When determined in advance the camera position 305 is preferably indicated on the layout 301. The entrance 307 is also drawn on the layout 301. A basic use of the camera position is to enable the association of a light source in the image with the correct mounting position by means of relating the image data with the camera position. Since it is possible to perform mutual comparisons between the detected light sources 103 or spots of light 115 it is not necessary to determine the camera position very accurate, but typically it is enough to know the approximate camera position that is obtained when a person places the camera in a position that the person has read out of a layout or been informed about in some other way. However, should a more accurate position be of interest, or in order to for example avoid “human errors”, the position determination device can be provided in the camera 111, and used.

By means of appropriate image processing it is possible to register images of the room 107, and more particularly of the illuminated areas 115, to detect the individual codes of the light of each area 115 and relate the detected code, i.e. light source 103, to a mounting position 303. This will be further explained below. Association of determined positions with a layout as such is described in WO 2006/095317, though in a quite different method where three reference nodes that have been placed in the structure and triangulation is used for performing position determinations for the light sources. Additionally, the triangulation is performed purely by means of RF signals.

Referring to the block diagram of FIG. 2, an embodiment of the lighting system 201 comprises several light sources 203, a camera 205, and a master controller 207. The master controller (MC) 207 comprises a signal processor (SP) 209, a control unit (CTRL) 211, and a synchronization unit (SYNC) 213. In this embodiment the lighting system is fully synchronized, i.e. the light sources 203 and the camera 205 are all connected to and synchronized by the synchronization unit 213, which is a reference frequency generator. More particularly, each light source 203 comprises a light coder 204, which is connected with the synchronization unit 213. Further, in this embodiment the light coder 204 is a modulation signal generator, which modulates the light by means of CDMA modulation. Thus, the emitted light carries CDMA codes, and the synchronization unit 213 synchronizes the CDMA modulation of all light sources 203. Further, the control unit 211 is connected to the light sources 203 for controlling their light output, for example as regards intensity, and/or colour, etc. The camera 205 comprises an image detector 217, which in turn comprises a matrix of detector elements 219, each generating one pixel of the registered image. An image signal output of the camera 205 is connected to the signal processor 209. In order to secure that the camera 205 is correctly positioned, or to obtain a more precise position of the camera 205, it is provided with a position determination device 215, such as a GPS or some other suitable device.

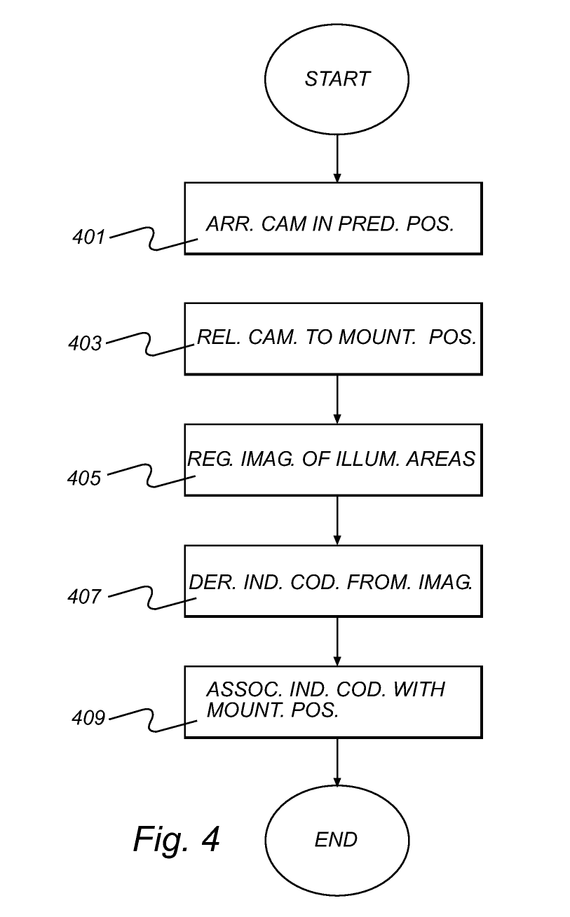

The operation of the lighting system, i.e. an embodiment of a method for processing light, will now be described with reference to the flow chart of FIG. 4. It is assumed that the light sources 103 have been arbitrarily mounted at the predetermined mounting positions of the ceiling, which mounting positions in turn have been arranged in accordance with the layout 301. First, at step 401, the camera 111 is placed in a camera position of the room 107, which camera position 305 is indicated on the layout. Then the position of the camera 111 is related to the mounting positions 303, at step 403. In practise, since the camera position 305 as well as the mounting positions 303 are predetermined, the position of the camera 111 relative to the mounting positions 303 is known. In this case the camera is placed in the left corner of the room 107 as seen from the entrance 113, 307. Additionally, the camera 111 is placed close to the ceiling 105 of the room 107 and inclined slightly downwards such that the areas 115 of the floor 109 illuminated by the emitted light are within the field of vision of the camera 111.

Then, at step 405, the camera 111 registers images of the illuminated areas 115 at a frequency that corresponds to, or is adapted to, the modulation frequency of the CDMA modulation. Thereby it is possible for the camera 111 to generate images that capture the different CDMA codes of the different illuminated areas 115. The images, thus obtained, or more particularly the image signals generated, are fed to the master controller 207, and more precisely to the signal processor 209, which derives the individual codes from the image signals, at step 407. The operation of deriving the codes is based, in this embodiment, on a pixel-by-pixel processing, where each detector element 219 generates a sub-signal of a total image signal. Thus, the sub-signals from the detector elements 219 carries information about the individual codes, and the positions of the detector elements 219 in the matrix, and thus in the image, are correlated with the position of the room. In particular, the mutual positions of the different light spots on the matrix are transferred to mutual positions on the layout 301. On basis thereof the master controller 207 then, at step 409, determines at which mounting position 303 each respective light source 103, 203 has actually been mounted, by associating the individual codes with the mounting positions 303.

This determination of which light sources are actually placed at the mounting positions is regarded as a commissioning. The scope of this invention cover also further light processing. In many applications, such as in an application for creating a particular atmosphere in the structure, or in an application where accurate light control is needed, the master controller 207 is used for controlling the light sources 103, 203 in order to generate certain light effects. Then a step of determining the intensity of light, or some other suitable property, of the light sources 103, 203 is added to the commissioning. Then the master controller learns not only the position of each light source but also its quantitative contribution. This kind of analyse of the emitted light is referred to as a foot-print measurement. Due to this information the master controller 207 is able to individually control the light sources 103, 203 as regards the output power, colour point, or the like. Then the registering of images is used for a feedback control of the light sources. It is possible to register and analyse the images at a rate that provides for real-time foot-print measurements. On the other hand, for pure commissioning the frequency can be lowered significantly.

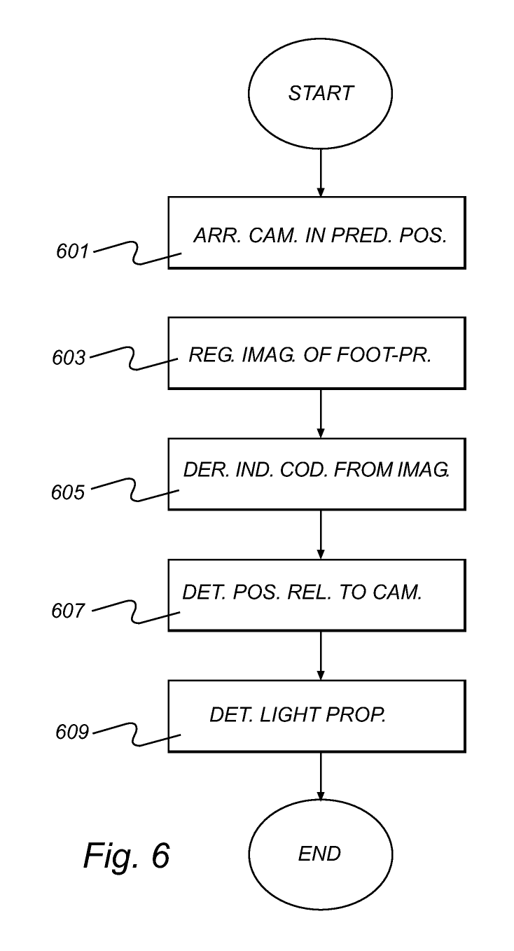

More particularly, foot-print measurements for determining a property of the emitted light, such as intensity, often start with a so called dark room calibration, where the foot-print of each individual light source is measured. In prior art dark room calibration was made by providing a dark environment, and then switching on one light source, measuring the foot-print, switching the light source off again, switching the next light source on, etc. In this method there is no need for switching any light source off or providing any dark environment. On the contrary it is possible, due to the ability to derive the individual codes from the images taken by the camera, to measure individual foot-prints when all light sources are switched on and in daylight. Furthermore, in contrast to the commissioning, the foot-print measurements do not require knowledge about the light source positions as such, i.e. in which mounting position each light source is placed. It may be helpful, though for some applications of the foot-print measurements. Thus, as illustrated in the flow chart of FIG. 6, in one embodiment of the present method, a dark room calibration type of foot-print measurement consists of the following steps. First, at step 601, the camera is arranged in a camera position, which is predetermined or determined on spot. Then, at step 603, the camera registers images of the foot-prints at the floor, which foot-prints are generated by the light emitted from the light sources. The rate of image registering preferably is high, such that the measurements are performed in real-time. The identifiers embedded in the registered light, i.e. the individual codes, are derived from the registered images, at step 605, by means of the signal processor. Next, at step 607, the position of each light source, associated with a respective one of the identifiers, relative to the camera position is determined. Finally, at step 609, a light property of each light source is determined by further image processing, or signal processing, on the registered images. Due to the identifiers it is possible to determine the individual contribution from each single light source. The light property typically is the light intensity. The light properties of the light sources are sent to the master controller, for further use, such as for generating a desired light atmosphere in the room or in a part of the room. Alternatively, depending on where the processing capacity is provided, the image data, i.e. the registered images, is sent directly to the master controller, which perform all signal processing. Since the master controller now knows the position of the camera and the positions of the light sources relative to the camera, it can calculate how to set different light sources in order to obtain a desired light atmosphere. Continuous foot-print measurements are then employable for light source control, by generating feed back data to the master controller.

In an alternative embodiment the lighting system operates asynchronous, as illustrated in FIG. 5. Previously it has sometimes been desirable to separate the emission of light from different light sources in time, in order to be able to detect the light emitted from a single light source at a time. However, by using the individual codes there is no need for a synchronisation in time of lamps, but the light sources can work in asynchronous mode. That is, the light sources embed individual codes, but the codes are asynchronous. In an alternative embodiment the lighting system operates such that the frequency of registering images is slowed down during commissioning and runs at full rate during foot-print measurements.

In an alternative embodiment of the lighting system 501, as shown in FIG. 5, the signal processor 509 is provided in the camera 505. Then the master controller 507 receives processed image data, which is further acted on by the control unit 511 for controlling the light sources 503.

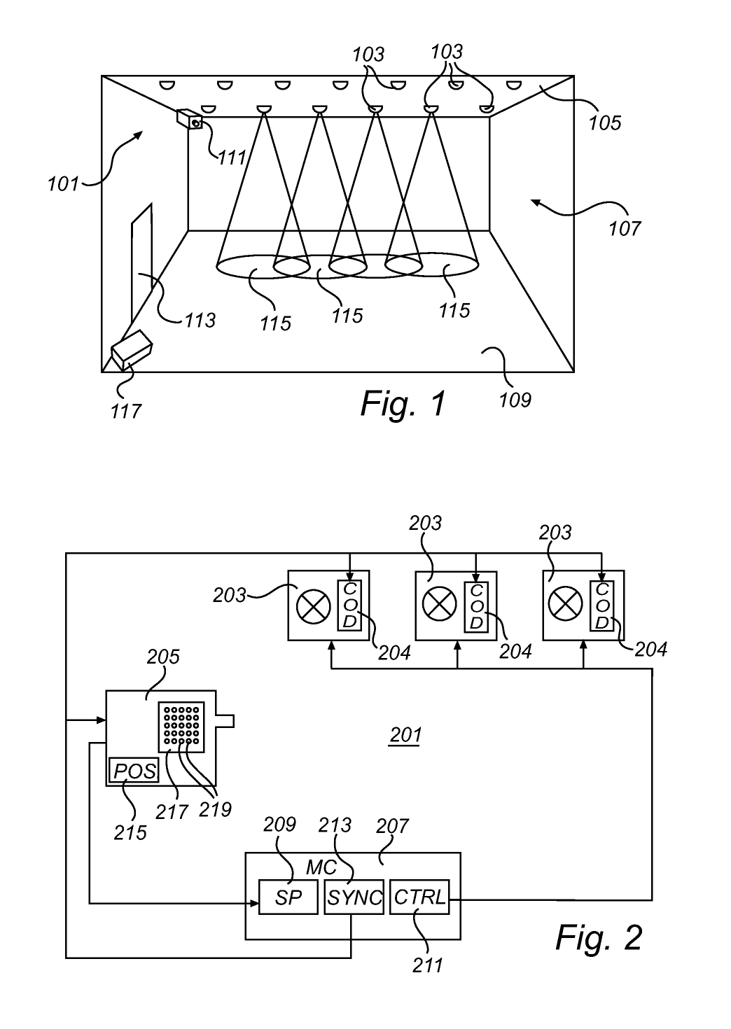

Instead of registering spots of light in the form of illuminated areas, the camera can be placed on the floor and pointed upwards for registering direct light from the light sources, as illustrated by dashed lines at 117 in FIG. 1. Then the spots of light are constituted by the output ends of the light sources 103.

Rather than using the advanced CDMA coding, although being advantageous, it is possible to use many different types of coding, as long as the codes are detectable and derivable by means of the camera and image processing apparatus of the lighting system. Thus, for instance, very simple or low frequency codes can be added to the light. Although the drawings illustrate wired connections, these should be interpreted figuratively, and can be wireless as well.

Above, the individual codes are generated at the light sources, but alternatively they are generated by the master controller and fed to the light sources. For instance, this can be implemented by means of an RF network interconnecting the master controller and the light sources, as for example disclosed in U.S. Pat. No. 6,969,954, which describes installing a lighting system where the light sources and a controller belong to an RF network. In such a case the codes can be obtained from the network or derived from the network addresses.

A further alternative embodiment of individual coding of the light sources is to provide the light sources with internal capability to randomly generate their own codes. This kind of code generation is particularly useful for the above-described monitoring application of creating an atmosphere in the structure.

In spite of what has been said above about separating the emission from the light sources in time, or rather in addition thereto, in an alternative embodiment time division multiple access (TDMA) techniques are employed. The light sources are then modulated such that they shine in non-overlapping time intervals. This simplifies the image processing of the registered foot-prints, since only a single foot-print at a time is registered. This embodiment can be further refined by separately measuring the background light when all light sources are switched off. The background contribution is subtracted from the foot-print measurements. The individual codes are still used for identifying the light sources.

Above, embodiments of a method for processing light and a lighting system according to the present invention as defined in the appended claims have been described. These should be seen as merely non-limiting examples. As understood by a skilled person, many modifications and alternative embodiments are possible within the scope of the invention.

It is to be noted, that for the purposes of this application, and in particular with regard to the appended claims, the word “comprising” does not exclude other elements or steps, that the word “a” or “an”, does not exclude a plurality, which per se will be apparent to a person skilled in the art.

1. A method for processing light in a structure having several light sources emitting light carrying individual codes, the method comprising:
arranging a camera (111, 205, 505) in the structure in a camera position for registering spots of said emitted light from the light sources;
registering, by means of said camera, images of said spots of light;
deriving said individual codes from the registered images; and
determining, for each individual code, at least one property related to the associated light source.

2. A method for processing light according to claim 1, wherein said at least one property comprises a light source position.

3. A method for processing light according to claim 2, wherein the structure has a plurality of predetermined mounting positions, wherein the light sources arbitrarily mounted at one or more of the mounting positions, and wherein said light source position is the mounting position in which the light source is mounted.

4. A method for processing light according to claim 2, wherein said light source position is a relative position in relation to said camera position.

5. A method for processing light according to claim 1, wherein the at least one light property comprises the determined light intensity of said light spots.

6. A method for processing light according to claim 1, wherein said individual codes are provided by means of modulating the light with individually coded modulation signals.

7. (canceled)

8. A method for processing light according to claim 6, wherein said modulation signals are synchronized.

9. A method for processing light according to claim 8, wherein said registering is synchronized with said modulation signals.

10. A method for processing light according to claim 1, wherein said light sources operate asynchronously.

11. A method for processing light according to claim 1, wherein said spots of light comprise at least one of: areas illuminated by the light sources, and output ends of the light sources.

12. A method for processing light according to claim 1, further comprising:
sending light source data, including image data related to said individual codes, generated by means of said camera to a master controller, which controls the light sources.

13. A method for processing light according to claim 5, further comprising:
sending light source data, including intensity data related to said measured intensity of light, generated by means of said camera to a master controller, which controls the light sources.

14. (canceled)

15. A lighting system arranged in a structure and comprising:
several light sources;
a signal processing apparatus, and
a camera, wherein each one of said light sources is provided with a light coder for individually coding the light emitted from the light source with an individual code; wherein said camera is arranged to register images of spots of light emitted from the light sources; and wherein said signal processing apparatus is arranged to derive said individual codes from the registered images and determine at least one property related to the associated light source.

16. A lighting system according to claim 15, further comprising a master controller for controlling said light sources.

17. A lighting system according to claim 15, wherein said signal processing apparatus is provided at the camera.

18. A lighting system according to claim 16, wherein said signal processing apparatus is provided at the master controller.

19. (canceled)

20. A lighting system according to claim 15, wherein said camera comprises a position determination device.

21. A lighting system according to claim 15, wherein said camera comprises an image detector comprising a matrix of detector elements (219) each generating one pixel of the registered image.

22. A lighting system according to claim 15, wherein said light coder is a modulator, which is arranged to modulate the light with a modulation signal.

23. A lighting system according to claim 22, wherein the modulation signals of the light sources are synchronized, and wherein the registering of images in the camera is synchronized accordingly.
